(19) United States
(12) Patent Application Publication
(10) Pub. No.: US 2016/0104125 A1
(43) Pub. Date: Apr. 14, 2016

(54) COMPUTING SYSTEM AND METHOD FOR PROVIDING INFORMATION RELATING TO MAINTENANCE ACTIONS

(71) Applicant: The Boeing Company, Chicago, IL (US)

(72) Inventors: Steven David Chapman, Chesterfield, MO (US); Peter Lake, Auburn, WA (US); Jay Kevin McCullough, Belleville, IL (US)

(21) Appl. No.: 14/511,901

(22) Filed: Oct. 10, 2014

(51) Int. Cl. G06Q 10/00; G06F 17/30

(52) U.S. Cl. CPC G06Q 10/20; G06F 17/30598

(57) ABSTRACT

A method, computing system and computer program product provide additional information relating to maintenance actions to address an issue with a structure. For each maintenance action that has corrected an issue, a first group of structures in which the issue has reoccurred and a second group of structures in which the issue has not reoccurred are identified. The method then determines an actual correction duration value for each of the structures in the first and second groups, generates a correction duration estimate for the structures in the first group using the actual correction duration values and uses the correction duration estimate to identify a portion of the structures in the second group. The method also uses the actual correction duration values calculated for the first group and the identified portion of the second group to generate a fix duration estimate representing an overall time estimation for issue reoccurrence.

### TECHNOLOGICAL FIELD

A computing system and method are provided for providing information relating to maintenance actions and, more particularly, for providing a fix duration estimate (FDE) representing an overall time estimation for reoccurrence of an issue following performance of a respective maintenance action.

### BACKGROUND

Following placement into service, structures may experience a variety of issues that are addressed by various maintenance actions. For example, vehicles, such as aircraft, may experience various issues after having been placed in service and, as such, may undergo maintenance actions intended to address the issues and to permit the vehicle to remain in service. Data regarding the various maintenance actions that are performed in order to resolve the various issues that a structure experiences may be recorded and maintained for future reference. The maintenance data provides a maintenance history for a structure and may serve both prognostic and diagnostic functions.

For example, the maintenance data may be reviewed in order to determine the different types of maintenance actions that have been performed over the course of time to resolve the same issue experienced by one or more structures, such as one or more aircraft. Based upon a review of this data, a confidence score in a respective maintenance action that serves to address an issue experienced by a structure may be determined. A technician may therefore consider the maintenance data including, for example, the confidence scores of various maintenance actions taken to resolve an issue in the past, in the course of determining the maintenance action to be performed in order to address the occurrence of the same issue with a structure. However, the confidence score does not provide any information as to how long the maintenance action will resolve the issue.

For example, a confidence score may indicate that a certain maintenance action will most likely resolve a specific issue. However, the confidence score does not provide any indication that, following the maintenance action implemented based in part by the confidence score, the same issue may or may not reoccur in a relatively short time.

### BRIEF SUMMARY

In an example embodiment, a method is provided for providing information relating to maintenance actions to address an issue. For a respective issue, the method includes identifying the maintenance actions that have been performed to correct the issue and that have corrected the issue. For each respective identified maintenance action, the method identifies a first group of structures for which the issue has reoccurred and a second group of structures for which the issue has not reoccurred. The method determines an actual correction duration value for each of the identified structures in the first and second groups. The method of this example embodiment also generates a correction duration estimate (X_{A}) for the structures in the first group using the actual correction duration values and uses the correction duration estimate (X_{A}) to identify a portion of the structures in the second group. Using the actual correction duration values calculated for the first group and the portion of the second group, the method generates a fix duration estimate (FDE) representing an overall time estimation for reoccurrence of the issue. Finally, the method causes the FDE to be presented in association with the respective maintenance action to the user.

The method of an example embodiment also includes generating an FDE for each identified maintenance action and presenting the FDEs and the associated maintenance actions as a list for each issue being addressed. The method may also present the FDE in association with a confidence score for the respective maintenance action. The FDE may be generated without consideration of the structures that have undergone the respective maintenance action to address the issue that has not since reoccurred and for which an elapsed time since performance of the respective maintenance action is less than the correction duration estimate (X_{A}).

The method of an example embodiment uses the correction duration estimate (X_{A}) to identify the portion of the structures in the second group by identifying the portion of the structures in the second group for which the time since the maintenance action was performed exceeds the correction duration estimate (X_{A}). In this example embodiment, the actual correction duration value may be defined to be the time since the maintenance action was performed for the portion of the structures in the second group. The generation of the FDE may include determining a sum of the actual correction duration values for the first group and the portion of the second group and dividing the sum by the total number of structures that are included in the first group and the portion of the second group. A system reset may comprise a maintenance action. In an example embodiment, only actions that resolve the issue, at least temporarily, comprise a maintenance action.

In another example embodiment, a computing system for providing information relating to maintenance actions to address an issue is provided. The computing system includes processing circuitry configured to, for a respective issue, identify the maintenance actions that have been performed to correct the issue and that have corrected the issue. For each respective identified maintenance action, the processing circuitry is also configured to identify the first group of structures for which the issue has reoccurred and a second group of structures for which the issue has not reoccurred. The processing circuitry of this example embodiment is also configured to determine an actual correction duration value for each of the identified structures in the first and second groups. The processing circuitry is configured to generate a correction duration estimate (X_{A}) for the structures in the first group using the actual correction duration values and to use the correction duration estimate (X_{A}) to identify a portion of the structures in the second group. The processing circuitry is configured to use the actual correction duration values calculated for the first group and the portion of the second group to generate a fix duration estimate (FDE) representing an overall time estimation for reoccurrence of the issue. The processing circuitry is further configured to cause the FDE to be presented in association with the respective maintenance action to the user.

The processing circuitry of an example embodiment is also configured to generate an FDE for each identified maintenance action and to present the FDEs and the associated maintenance actions in a list for each issue being addressed. The processing circuitry of an example embodiment is also configured to present the FDE in association with a confidence score for the respective maintenance action. The FDE may be generated without consideration of the structures that have undergone the respective maintenance action to address the issue that has not since reoccurred and for which an elapsed time since performance of the respective maintenance action is less than the correction duration estimate (X_{A}).

The processing circuitry of an example embodiment is configured to use the correction duration estimate (X_{A}) to identify the portion of the structures in the second group by identifying the portion of the structures in the second group for which the time since the maintenance action was performed exceeds the correction duration estimate (X_{A}). The actual correction duration value may be defined to be the time since the maintenance action was performed for the portion of the structures in the second group. The processing circuitry of this example embodiment is also configured to generate the FDE by determining a sum of the actual correction duration values for the first group and the portion of the second group and by dividing this sum by a total number of structures that are included in the first group and the portion of the second group.

In a further example embodiment, a computer program product is provided for providing information related to maintenance actions to address an issue. The computer program product includes at least one non-transitory computer-readable storage medium having computer-executable program code instructions stored therein. The computer-executable program code instructions include program code instructions for identifying, for a respective issue, the maintenance actions that have been performed to correct the issue and that have corrected the issue. For each respective identified maintenance action, the computer-executable program code instructions include program code instructions for identifying a first group of structures for which the issue has reoccurred and a second group of structures for which the issue has not reoccurred. The computer-executable program code instructions also include program code instructions for determining an actual correction duration value for each of the identified structures in the first and second groups, program code instructions for generating a correction duration estimate (X_{A}) for the structures in the first group using the actual correction duration values and program code instructions for using the correction duration estimate (X_{A}) to identify a portion of the structures in the second group. The computer-executable program code instructions also include program code instructions for using the actual correction duration values calculated for the first group and the portion of the second group to generate a fix duration estimate (FDE) representing an overall time estimation for reoccurrence of the issue and program code instructions for causing the FDE to be presented in association with the respective maintenance actions to the user.

The computer-executable program code instructions of an example embodiment also include program code instructions for generating an FDE for each identified maintenance action and for presenting the FDEs and the associated maintenance actions as a list for each issue being addressed. The program code instructions for causing the FDE to be presented may include program code instructions for presenting the FDE in association with the confidence score for the respective maintenance action. In an example embodiment, the FDE is generated without consideration of the structures that have undergone the respective maintenance action to address the issue that has not since reoccurred and for which an elapsed time since performance of the respective maintenance action is less than the correction duration estimate (X_{A}).

In an example embodiment, the program code instructions for using the correction duration estimate (X_{A}) to identify the portion of the structures in the second group include program code instructions for identifying the portion of the structures in the second group for which the time since the maintenance action was performed exceeds the correction duration estimate (X_{A}). The actual correction duration value may be defined to be the time since the maintenance action was performed for the portion of the structures in the second group. In this example embodiment, the program code instructions for generating the FDE include program code instructions for determining a sum of the actual correction duration values for the first group and the portion of the second group and program code instructions for dividing the sum by a total number of structures that are included in the first group and the portion of the second group.

### BRIEF DESCRIPTION OF THE DRAWINGS

Having thus described aspects of the present disclosure in general terms, reference will now be made to the accompanying drawings, which are not necessarily drawn to scale, and wherein:

FIG. 1 is a block diagram of a computing system that may be specifically configured in accordance with an example embodiment of the present disclosure;

FIG. 2 is a flowchart illustrating operations performed, such as by the computing system of FIG. 1, in accordance with an example embodiment of the present disclosure;

FIG. 3a is a bar graph illustrating actual correction duration values for each of a plurality of structures that have undergone the same maintenance action to address the same issue for all structures, regardless of whether the issue has reoccurred;

FIG. 3b is a bar graph illustrating the actual correction duration values for each of a plurality of structures that have undergone the same maintenance action to address the same issue that has since reoccurred relative to an average time for reoccurrence for the structures with the actual correction duration value being the elapsed time from the performance of the maintenance action to the reoccurrence of the same issue;

FIG. 3c is a bar graph illustrating the times since the performance of a maintenance action to address an issue that has not reoccurred, relative to the average time for reoccurrence, for each of a plurality of structures that have undergone the same maintenance action to address the same issue that has not since reoccurred; and

FIG. 4 is an example presentation of the fix duration estimate representative of an overall time estimation for reoccurrence for each of a plurality of maintenance actions and in association with corresponding confidence scores in accordance with an example embodiment of the present disclosure.

### DETAILED DESCRIPTION

The present disclosure now will be described more fully hereinafter with reference to the accompanying drawings, in which some, but not all aspects are shown. Indeed, the disclosure may be embodied in many different forms and should not be construed as limited to the aspects set forth herein. Rather, these aspects are provided so that this disclosure will satisfy applicable legal requirements. Like numbers refer to like elements throughout.

Described herein are a method, computing system and computer program product in accordance with example embodiments of the present disclosure. In general, the method of an example embodiment includes generating a table or list that includes a plurality of maintenance actions that may be implemented to correct a single fault, for example, a fault indicated on a structure, such as an airplane. The method further includes generating a fix duration estimate (FDE) for each of the maintenance actions on the list. Optionally, the method may include displaying an associated confidence score with each respective FDE. It should be realized that each structure, such as each aircraft, may experience many fault indications. Thus, a table or list may be generated for each specific fault indicated.

In operation, the table or list referenced above is used to provide a technician or other user with additional information as to a course of action that may be taken to resolve a specific issue and the FDE provides a numerical indication as to how long each course of action may prohibit the same issue from reoccurring in the future.

As used, herein, the term “correct” as in “correct a fault”, refers to maintenance action that is taken to address a fault that results in the fault not reoccurring for at least a predetermined quantity of time. For example, assume that the predetermined quantity of time is 7 days. Moreover, assume that a maintenance action A is performed on an aircraft in response to a Fault F. Finally, assume that the same fault F reoccurs within 2 days. In this case, the maintenance action A did not “correct” the fault F. However, assume that a maintenance action B was performed on the same fault and the fault reoccurred after 9 days. In this case, maintenance action B is considered to have “corrected” the fault F. It should be realized that the predetermined time may be set for any amount of hours, days, months, etc. and seven days is exemplary.

FDE, as used herein, is a numerical value that represents an estimate of a time duration that a given fix, e.g. performance of a specific maintenance action, will prohibit the same issue from reoccurring.

In general, the FDE's are calculated based on a priori maintenance data history. Such data history includes, for example, a list of issues observed for a specific structure, a list of potential maintenance actions that may be implemented to address each specific issue, and a list of times that each maintenance action was effective, e.g. the quantity of time between when the maintenance action was initially performed on the structure to resolve the issue and the time when the same issue reoccurred on the same structure, i.e. the time the fault is corrected.

In operation, an FDE is calculated for each of a plurality of potential maintenance actions that have been determined to be effective in correcting the respective issue. For example, assume an issue I occurs. Moreover, assume that any of maintenance actions A, B, C, D, or E have been identified as effective in correcting the issue I. In this case, an FDE for each of the maintenance actions A, B, C, D, and E is calculated and displayed to a user. The user may then use the confidence scores and the associated FDEs to select a maintenance action as is described in more detail below.

A method, computing system and computer program product are provided according to embodiments of the present disclosure in order to provide information relating to maintenance actions to address an issue, such as a fault, with a structure. In this regard, the information that is provided may include the FDE representative of an overall time estimation for reoccurrence of the issue following performance of the respective maintenance actions. As described above, this additional information, e.g., FDE, may be provided in association with a confidence score associated with each respective maintenance actions. By considering the FDE and, in some example embodiments, the confidence score in the respective maintenance actions, a technician or other user may make an informed decision regarding which of the maintenance actions to employ in order to address the issue with the structure, such as by selecting the maintenance action that has the best combination of a confidence score and a larger FDE. Thus, the structure may be maintained in an efficient manner that may ensure that issues with the structure are addressed in a manner that takes into account the potential reoccurrence of the same issue.

The structures that may undergo maintenance actions for which information is provided in accordance with an example embodiment may be any of a wide variety of structures. For example, the structures that may undergo maintenance action may include vehicles, such as aircraft. Regardless of the type of structure, the maintenance actions may be performed to address a wide variety of issues, including issues relating to, for example, structural integrity, aesthetic features, under performance of a component, failure of a component or the like. At least some of the issues may be addressed by a plurality of maintenance actions, such as replacing a component, replacing a sensor, resetting the system, replacing wiring or the like. In regards to the maintenance actions, a system reset may be considered a maintenance action in an instance in which the system reset resolves the issue, at least temporarily. More generally, only those actions that resolve the issue, at least temporarily, may be considered maintenance actions with other actions, such as the repair or replacement of components, that do not serve to resolve the issue even temporarily not being considered maintenance actions.

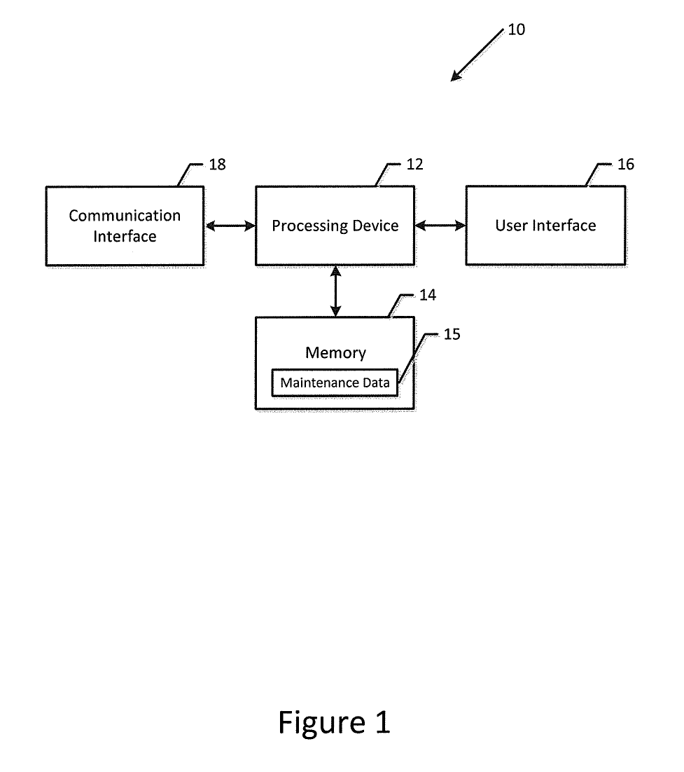

In an example embodiment, a computing system 10 may be configured to provide the information relating to the maintenance actions that have been undertaken to address an issue with a structure. Although the computing system may be configured in a variety of different manners, FIG. 1 depicts an example of a computing system, such as a maintenance computer, that may be embodied by a server, a personal computer, a tablet computer or the like. However, other types of computing systems may embody the method and computer program product of an embodiment of the present disclosure.

Regardless of the instantiation of the computing system 10, the computing system may be configured in various manners. By way of example, the computing system of one embodiment is shown in FIG. 1 to include or otherwise be associated with a processing circuitry 12, memory 14 and optionally a user interface 16 and/or a communication interface 18 for performing the various functions herein described. The processing circuitry may, for example, be embodied as various means including one or more microprocessors, one or more coprocessors, one or more multi-core processors, one or more controllers, one or more computers, various other processing elements including integrated circuits such as, for example, an ASIC (application specific integrated circuit) or FPGA (field programmable gate array), or some combination thereof. In some example embodiments, the processing circuitry is configured to execute instructions stored in the memory 14 or otherwise accessible to the processing circuitry. These instructions, when executed by the processing circuitry, may cause the computing system to perform one or more of the functionalities described herein. As such, the computing system may comprise an entity capable of performing operations according to embodiments of the present disclosure while configured accordingly. Thus, for example, when the processing circuitry is embodied as an ASIC, FPGA or the like, the processor and, correspondingly, the computing system may comprise specifically configured hardware for conducting one or more operations described herein. Alternatively, as another example, when the processing circuitry is embodied as an executor of instructions, such as may be stored in the memory, the instructions may specifically configure the processing circuitry and, in turn, the computing system to perform one or more algorithms and operations described herein.

The memory 14 may include, for example, volatile and/or non-volatile memory. The memory may comprise, for example, a hard disk, random access memory, cache memory, flash memory, an optical disc (e.g., a compact disc read only memory (CD-ROM), digital versatile disc read only memory (DVD-ROM), or the like), circuitry configured to store information, or some combination thereof. In this regard, the memory may comprise any non-transitory computer readable storage medium. The memory may be configured to store information, data, applications, instructions, or the like for enabling the computing system 10 to carry out various functions in accordance with example embodiments of the present disclosure. For example, the memory may be configured to store program instructions for execution by the processing circuitry 12.

The user interface 16 may be in communication with the processing circuitry 12 and the memory 14 to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms.

The communication interface 18 may also optionally be in communication with the processing circuitry 12 and the memory 14 and may be configured to receive and/or transmit data from/to a communications device in communication with the computing system 10, such as to facilitate communications with other computing devices via a network The communication interface may include, for example, one or more antennas and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication.

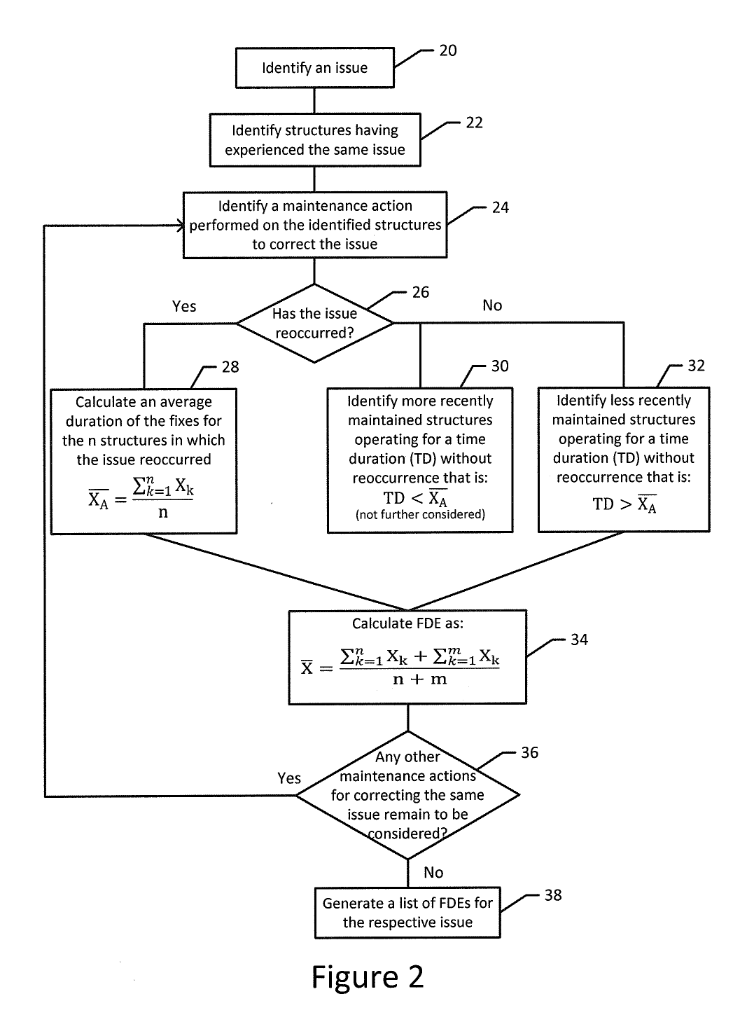

Regardless of the manner in which the computing system 10 is configured, the computing system, such as the processing circuitry 12, may be configured to determine, for one or more structures that have experienced a respective issue, the various maintenance actions that have been undertaken to resolve the issue. As shown in blocks 20 and 22 of FIG. 2, for example, the processing circuitry may be configured to identify an issue, such as a fault, and, in turn, to identify the structures that have experienced the same issue. Thereafter, the processing circuitry may be configured to identify each maintenance action that was performed in order to correct the issue and that actually corrected the issue, at least for a predetermined quantity of time. See block 24. In order to identify the issue, the structures that have experience the same issue and the maintenance actions performed to correct the issue, the processing circuitry may access and review maintenance data 15 stored by the memory 14.

For example, structures A, B and C may all have experienced the same issue, that is, Issue 1. From a review of the maintenance data 15 stored, for example, by the memory 14, the processing circuitry 12 of the computing system 10 may be configured to determine that Issue 1 was resolved by maintenance action X for structure A, by maintenance action Y for structure B and first by maintenance action X and then, following reoccurrence of the same issue, by maintenance action Z for structure C. In addition to identifying the maintenance actions that have been undertaken to address an issue, the processing circuitry may also determine, such as from a review of the maintenance data stored, for example, by the memory 14, the time at which each maintenance action was performed, whether the issue reoccurred following the performance of a respective maintenance action and, in an instance in which the issue did reoccur, the time at which the issue reoccurred.

For each maintenance action that has been performed to address the issue in one or more of the structures, the computing system 10, such as the processing circuitry 12, may be configured to identify a first group of structures that have undergone the maintenance action to address the issue and the issue has since reoccurred, that is, the issue has reoccurred since the performance of the maintenance action, and to also identify a second group of structures that have also undergone the maintenance action to address the issue and the issue has not reoccurred. See block 26 of FIG. 2. The computing system, such as the processing circuitry, is also configured to determine the actual correction duration value for each of the structures in the first and second groups. In this regard, the actual correction duration value for a structure in the first group is the elapsed time from the performance of the maintenance action to the reoccurrence of the issue. In contrast, the actual correction duration value for a structure in the second group is the elapsed time from the performance of the maintenance action to the time at which the FDE is generated, since the structure in the second group has not experienced a reoccurrence of the issue following performance of the maintenance action.

As shown in block 28 of FIG. 2, the computing system 10, such as the processing circuitry 12, may be configured to generate a correction duration estimate (X_{A}) for the structures in the first group using their actual correction duration values. In this regard, the processing circuitry is configured to determine, for each respective maintenance action, an average time until reoccurrence for those structures of the first group, that is, those structures that have previously undergone the respective maintenance action and that have experienced a reoccurrence of the same issue. In this regard, the actual correction duration value for a respective structure may be represented as xₖ with k designating a particular one of the maintenance actions performed to address the issue. Thus, the computing system, such as the processing circuitry, may be configured to determine the average time as follows:

$$\overline{{x}_{A}} = \frac{{\sum }_{k = 1}^{n} {x}_{k}}{n}$$

wherein n is the total number of structures in the first group for which maintenance action k has been performed to address the respective issue that has since reoccurred.

The computing system 10, such as the processing circuitry 12, may also be configured to use the correction duration estimate (X_{A}) to identify a portion of the structures in the second group. In this regard, the processing circuitry may be configured to distinguish, for those structures of the second group that have undergone a maintenance action to address the issue and for which the issue has not reoccurred, between more recently maintained structures and less recently maintained structures. In this regard, the less recently maintained structures may be distinguished from the more recently maintained structures based upon a comparison of the actual correction duration values, that is, a comparison on the time since the maintenance action was performed to the correction duration estimate (X_{A}) representative of the average time until reoccurrence, such as described above, for those structures of the first group that have undergone a respective maintenance action and have experienced a reoccurrence of the same issue. In this regard, more recently maintained structures may be those for which the time since the maintenance action was performed is less than the correction duration estimate (X_{A}), while less recently maintained structures may be those for which the time since the maintenance action was performed is greater than the correction duration estimate (X_{A}). See blocks 30 and 32 of FIG. 2 with respect to the identification of more recently maintained structures and less recently maintained structures, respectively.

By way of further explanation, for example, the processing circuitry 12 may be configured to compare the time since the maintenance action was performed to the correction duration estimate (X_{A}) for those structures that have previously undergone a respective maintenance action that have experienced a reoccurrence of the issue. In instances in which the time since the maintenance action was performed is less than the correction duration estimate (X_{A}), the structure may be classified as a more recently maintained structure. Conversely, in an instance in which the time since the maintenance action was performed is greater than the correction duration estimate (X_{A}), the structure may be classified as a less recently maintained structure. By using the correction duration estimate (X_{A}), the processing circuitry may identify the portion of the structures in the second group to include the less recently maintained structures, but not the more recently maintained structures. Thus, the portion of the structures in the second group that are identified using the correction duration estimate (X_{A}) are those structures that have not experienced a reoccurrence of the issue and for which the elapsed time since the performance of the maintenance action exceeds the correction duration estimate (X_{A}). This process may be repeated for each structure that has undergone a maintenance action to address the issue and for which the issue has not reoccurred.

Using the actual correction duration values calculated for the first group and the portion of the second group of structures, the computing system 10, such as the processing circuitry 12, may also be configured to determine an FDE representing an overall time estimation for recurrence of the issue. See block 34 of FIG. 2. The determination of the FDE representing an overall time estimation for reoccurrence of the issue may be based on two or more factors. In this regard, the FDE may be based on the time until reoccurrence for the first group of structures that have previously undergone a respective maintenance action and that have experienced a reoccurrence of the issue. Additionally, the FDE may also be based on the time since the maintenance action was performed for the portion of the structures in the second group that have been identified, that is, the less recently maintained structures for which the issue has not reoccurred. In regard to the portion of the structures in the second group that have been identified as less recently maintained structures for which the issue has not reoccurred, a time until reoccurrence may be defined to be the time since the maintenance action was performed. Thus, even though the issue has not reoccurred for the portion of the structures in the second group that have been identified, an actual correction duration value may be defined as described above and, more particularly, may be conservatively defined to be the time since the maintenance action was performed until the time at which the FDE is generated for these less recently maintained structures, such as would be the case in which a less recently maintained structure suddenly had a reoccurrence of the issue at the time at which the FDE was generated.

In order to determine the FDE representing the overall time estimation for reoccurrence, the computing system 10, such as the processing circuitry 12, may be configured to determine a sum of: (i) the actual correction duration values for the first group of structures that have previously undergone a respective maintenance action and that have experienced a reoccurrence of the issue and (ii) the actual correction duration values for the portion of the second group of structures that has been identified as the less recently maintained structures for which the issue has not reoccurred. In this example embodiment, the computing system, such as the processing circuitry, determines the FDE representing the overall time estimation for reoccurrence by dividing the sum by the total number of structures that are included in the first group and the portion of the second group. In other words, the computing system, such as the processing device, may be configured to determine the overall time estimation for reoccurrence as follows:

$$\overline{x} = \frac{{\sum }_{k = 1}^{n} {x}_{k} + {\sum }_{k = 1}^{m} {x}_{k}}{n + m}$$

wherein n is the number of structures in the first group, and m is the number of structures in the portion of the second group that have been identified.

In regards to the more recently maintained structures for which the issue has not reoccurred, the computing system 10 of an example embodiment may be configured to determine the FDE representing the overall time estimation for reoccurrence without consideration of the more recently maintained structures for which the issue has not reoccurred. See block 30 of FIG. 2 which indicates that the more recently maintained structures for which the issue has not reoccurred are not further considered. In this embodiment, the more recently maintained structures for which the issue has not reoccurred are not considered in the determination of the FDE representing the overall time estimation for reoccurrence since the time since the maintenance action was performed is less than the correction duration estimate (X_{A}) such that inclusion of the actual time since the maintenance action was performed for these more recently maintained structures in the determination of the FDE may undesirably downwardly skew the FDE.

In an alternative embodiment, the time until reoccurrence for the more recently maintained structures for which the issue has not reoccurred may be defined to be the correction duration estimate (X_{A}), that is, the average time until reoccurrence that is determined in block 28 of FIG. 2 for the first group of structures that have previously undergone a respective maintenance action and that have experienced a reoccurrence of the issue. In this regard, the time until reoccurrence for the more recently maintained structures may be defined to be the correction duration estimate (X_{A}) since, on average, it is anticipated that each of these more recently maintained structures will not suffer reoccurrence of the issue until the elapsed time since the maintenance action was performed equals the correction duration estimate (X_{A}). In this example embodiment, the computing system 10, such as the processing circuitry 12, may be configured to determine the FDE representing the overall time estimation for reoccurrence in a manner that is also based on the time until reoccurrence (as defined to be the correction duration estimate (X_{A})) for the more recently maintained structures for which the issue has not reoccurred.

Thus, the computing system 10, such as the processing circuitry 12, of this example embodiment may determine the sum to include not only: (i) the actual correction duration values for the first group of structures that have previously undergone a respective maintenance action and that have experienced a reoccurrence of the issue and (ii) the actual correction duration values for the portion of the second group of structures that has been identified as the less recently maintained structures for which the issue has not reoccurred, but also (iii) the times until reoccurrence as defined to be the correction duration estimate (X_{A}) for the more recently maintained structures for which the issue has not reoccurred. In this example embodiment, the computing system, such as the processing circuitry, would also be configured to divide the sum by the total number of structures in the first and second groups. Since the time until reoccurrence for more recently maintained structures is defined to be the correction duration estimate (X_{A}), the inclusion of the more recently maintained structures in the determination of the FDE will result in the determination of the same FDE as if the more recently maintained structures were not considered during the determination of the FDE. However, by considering the portion of the structures in the second group that have been identified as less recently maintained structures in the manner described above, the additional information provided by the portion of the structures in the second group that have not yet suffered a reoccurrence will further inform the FDE by increasing the FDE relative to the correction duration estimate (X_{A}) for the structures of the first group that have previously undergone a respective maintenance action and that have experienced a reoccurrence of the issue, but does so in a conservative manner by defining the actual correction duration value for the portion of the structures in the second group that have been identified as the less recently maintained structures for which the issue has not yet reoccurred to be the elapsed time since the performance of the maintenance action.

The process described above in regards to the determination of the FDE representing the overall time estimation for reoccurrence of the issue following performance of a respective maintenance action may be repeated for each different maintenance action that has been performed on any of the structures to correct the same fault. See block 36 of FIG. 2. For a fault that has been corrected by a plurality of different maintenance actions, the method, computing system 12 and computer program product of an example embodiment may determine the FDE representing the overall time estimation for reoccurrence for each of the different maintenance actions to permit a technician or other user to compare the different maintenance actions.

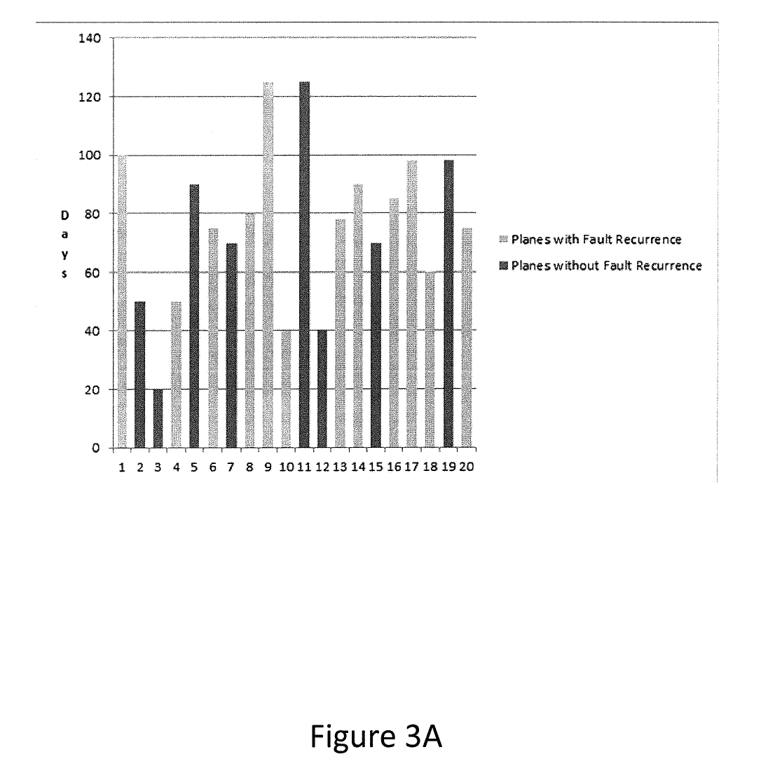

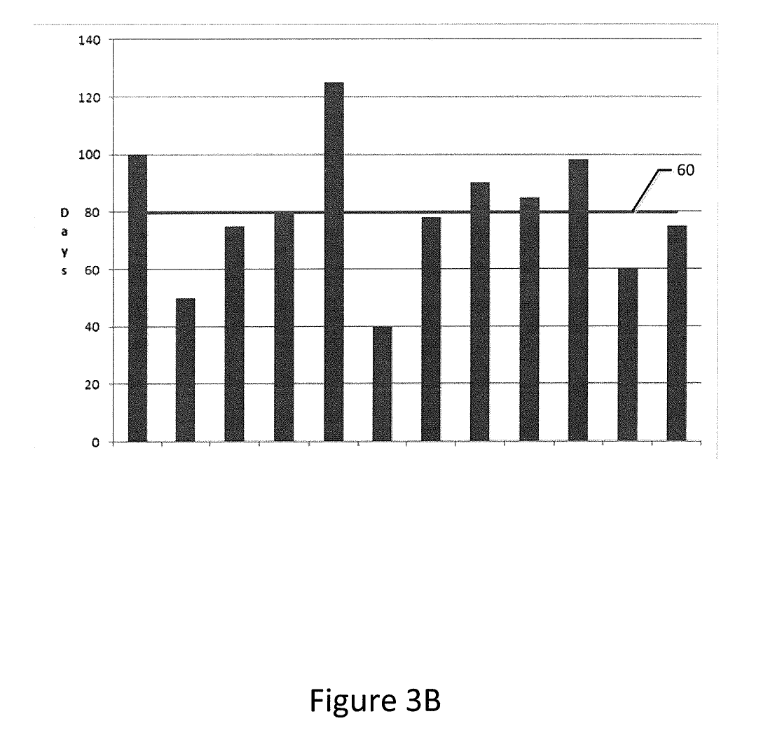

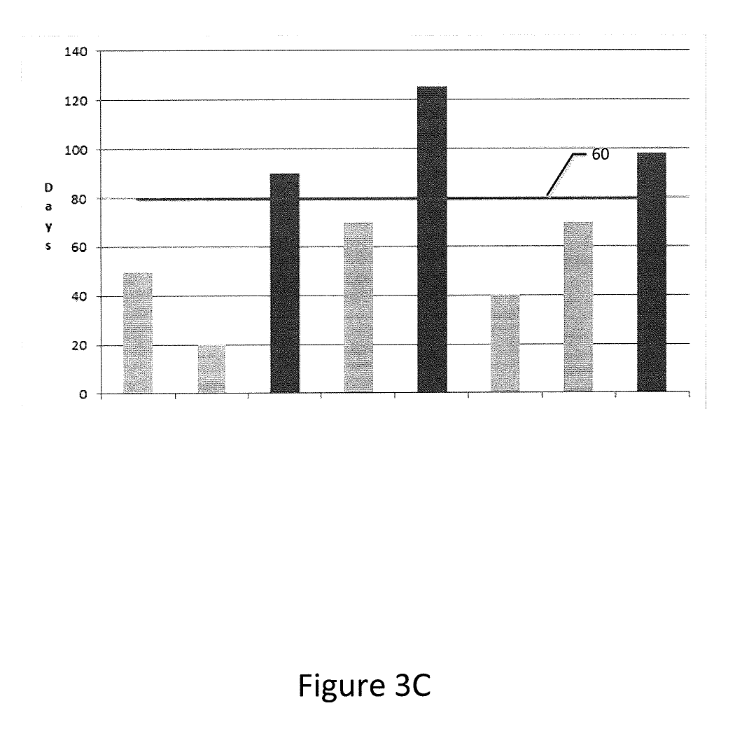

By way of example, FIG. 3A is a bar graph that depicts maintenance data associated with 20 airplanes that have undergone a respective maintenance action to address the same issue. Of the 20 airplanes, 12 airplanes as represented by the lighter bars have experienced a reoccurrence of the same issue and would be identified to be in the first group and 8 airplanes as represented by the darker bars have not experienced a reoccurrence of the same issue and would be identified to be in the second group. For the airplanes that have experienced a reoccurrence of the issue, the vertical bars of FIG. 3A depict the actual correction duration value, that is, the time that elapsed between the performance of the maintenance action and the reoccurrence of the issue. For the airplanes that have not experience a reoccurrence of the issue, the vertical bars of FIG. 3A depict the actual correction duration value, that is, the time that has elapsed since the performance of the maintenance action.

Referring now to FIG. 3B, the first group of the airplanes that have undergone a respective maintenance action to address an issue only to have experienced a reoccurrence of the issue, e.g., the airplanes represented by lighter bars in FIG. 3A, are depicted with the correction duration estimate (X_{A}) representing the average time until reoccurrence as shown by the horizontal line 60. In this regard, the correction duration estimate (X_{A}) for the first group of airplanes depicted in FIG. 3B that have previously undergone a respective maintenance action and that have experienced a reoccurrence of the same issue may have been determined as follows:

(100+50+75+80+125+40+78+90+85+98+60+75)/12=79.67

Referring now to FIG. 3C, the second group of airplanes that have undergone a respective maintenance action to address an issue and that have not experienced a reoccurrence of the issue, e.g., the airplanes represented by darker bars in FIG. 3A, are depicted. Additionally, a horizontal line 60 representative of the correction duration estimate (X_{A}) for the first group of structures that have previously undergone a respective maintenance action and that have experienced a reoccurrence of the issue is illustrated. As shown in FIG. 3C, the portion of the second group of airplanes that would be identified include the 3 airplanes that are considered less recently maintained structures since the actual correction duration value for the aircraft is greater than the correction duration estimate (X_{A}), while the other 5 airplanes of the second group would not be included in the identified portion and would, instead, be considered more recently maintained structures since the actual correction duration value is less than the correction duration estimate (X_{A}). As such, the actual correction duration value for the identified portion of the second group of structures may be defined to be the time since the maintenance action was performed. As such, the computing system 10, such as the processing device 12, of this example embodiment may determine the FDE representing the overall time estimation for reoccurrence by including the actual correction duration values for the less recently maintained structure that comprise the identified portion of the second group as follows:

(100+50+75+80+125+40+78+90+85+98+60+75+90+125+98)/(12+3)=84.6

As will be recognized in the foregoing equation, the additional terms of 90, 125 and 98 in the numerator are the days that have elapsed since the maintenance action was performed for the less recently maintained structures that have not experienced a reoccurrence of the issue, and the term 3 in the denominator is indicative of the three additional airplanes, that is, the three less recently maintained structures, that are included in the calculation.

As this example illustrates, the inclusion of a conservative estimate of the actual correction duration value for the less recently maintained structures for which the issue has not reoccurred may increase the FDE relative to the correction duration estimate (X_{A}) that was previously determined for those structures of the first group that have undergone a respective maintenance action and that have experienced a reoccurrence of the issue. However, the determination of the FDE and its increase relative to the correction duration estimate (X_{A})is performed in a conservative manner by treating the less recently maintained structures as though they each experienced a reoccurrence of the issue at the present time.

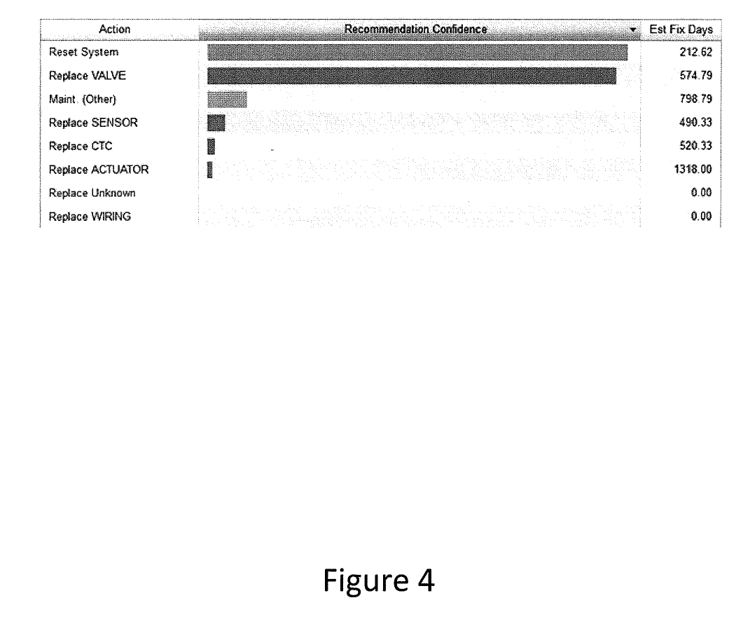

As shown in block 38 of FIG. 2 and in FIG. 4, the computing system 10, such as the processing circuitry 12, may also be configured to cause the FDE representing the overall time estimation for reoccurrence to be presented, such as via the user interface 16, e.g., a display, in association with a confidence score in a respective maintenance action. By way of illustration, FIG. 4 depicts a list of the FDE (designated “Est Fix Days”) for each of the plurality of different maintenance actions that have been performed on different structures in order to address the same issue. Each FDE is presented along with a confidence score in the respective maintenance action. Based upon the FDE representing the overall time estimation for reoccurrence and the confidence score, a technician or other user may make a more informed decision regarding the maintenance action to be performed in response to the reoccurrence of the issue.

With reference to FIG. 4, for example, the system reset and the replacement of a valve may have relatively similar and very large confidence scores. However, the replacement of the valve may have a substantially larger overall time estimation for reoccurrence and, as such, may counsel the technician to proceed to replace the valve such that the resulting structure likely remains operational without reoccurrence of the issue for a longer period of time, thereby increasing the efficiency with which the maintenance operations are performed and the structure is serviced.

The computing system 10, such as the processing circuitry 12, may be configured to determine the confidence score in various manners, such as based upon the number of times that a respective maintenance action has served to address the issue and the confidence in those determinations. Additionally, the computing system, such as the processing circuitry, may be configured to consider the age of the data relating to the maintenance actions that were performed to address an issue in the determination of the confidence score with older data resulting in lower confidence scores than more recent data.

As described above, a method, computing system 10 and computer program product are disclosed in order to provide additional information relating to maintenance actions to address an issue with a structure. The method, computing system and computer program product of an example embodiment may provide information regarding the FDE representing the average time for reoccurrence of the issue following performance of a respective maintenance action. As such, a technician or other user may make a more informed or educated decision regarding the preferred maintenance action to address the issue. For example, the technician or other user may elect to perform the maintenance action that defers reoccurrence of the issue for a longer period of time than other maintenance actions, thereby potentially improving the efficiency with which a structure is maintained.

As described above, FIG. 2 illustrates a flowchart of a system, method, and computer program product according to example embodiments of the present disclosure. It will be understood that each block of the flowchart, and combinations of blocks in the flowchart, may be implemented by various means, such as hardware and/or a computer program product comprising one or more computer-readable storage mediums having computer readable program instructions stored thereon. For example, one or more of the procedures described herein may be embodied by computer program instructions of a computer program product. In this regard, the computer program product(s) which embody the procedures described herein may be stored by one or more memory devices 14 of a computing system 10 and executed by a processing circuitry 12 of the computing system. In some embodiments, the computer program instructions comprising the computer program product(s) which embody the procedures described above may be stored by a plurality of memory devices. As will be appreciated, any such computer program product may be loaded onto a computer or other programmable apparatus to produce a machine, such that the computer program product including the instructions which execute on the computer or other programmable apparatus creates means for implementing the functions specified in the flowchart blocks. Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart blocks. The computer program instructions of one or more computer program products may also be loaded onto the computing system or other programmable apparatus to cause a series of operations to be performed on the computing system or other programmable apparatus to produce a computer-implemented process such that the instructions which execute on the computing system or other programmable apparatus implement the functions specified in the flowchart blocks.

Accordingly, blocks or steps of the flowchart support combinations of means for performing the specified functions and combinations of steps for performing the specified functions. It will also be understood that one or more blocks of the flowchart, and combinations of blocks in the flowchart, may be implemented by special purpose hardware-based computer systems which perform the specified functions or steps, or combinations of special purpose hardware and computer program products.

The above described functions may be carried out in many ways. For example, any suitable means for carrying out each of the functions described above may be employed to carry out embodiments of the present disclosure. In one embodiment, a suitably configured computing system 10 may provide all or a portion of the elements of the present disclosure. In another embodiment, all or a portion of the elements may be configured by and operate under control of a computer program product. The computer program product for performing the methods of embodiments of the present disclosure includes a computer-readable storage medium, such as the non-volatile storage medium, and computer-readable program code portions, such as a series of computer instructions, embodied in the computer-readable storage medium.

Many modifications and other aspects of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

What is claimed is:

1. A method for providing information relating to maintenance actions to address an issue, the method comprising:
for a respective issue, identifying the maintenance actions that have been performed to correct the issue and that have corrected the issue;
for each respective identified maintenance action, identifying a first group of structures wherein the issue has reoccurred and a second group of structures wherein the issue has not reoccurred;
determining an actual correction duration value for each of the identified structures in the first and second groups;
generating a correction duration estimate (X_{A}) for the structures in the first group using the actual correction duration values;
using the correction duration estimate (X_{A}) to identify a portion of the structures in the second group;
using the actual correction duration values calculated for the first group and the portion of the second group to generate a fix duration estimate (FDE) representing an overall time estimation for reoccurrence of the issue; and
causing the FDE to be presented in association with the respective maintenance action to the user.

2. The method of claim 1 further comprising:
generating an FDE for each identified maintenance action; and
presenting the FDEs and the associated maintenance actions as a list for each issue being addressed.

3. The method of claim 1 wherein causing the FDE to be presented comprises presenting the FDE in association with a confidence score for the respective maintenance action.

4. The method according to claim 1 wherein the FDE is generated without consideration of the structures that have undergone the respective maintenance action to address the issue that has not since reoccurred and for which an elapsed time since performance of the respective maintenance action is less than the correction duration estimate (X_{A}).

5. The method according to claim 1 wherein using the correction duration estimate (X_{A}) to identify the portion of the structures in the second group comprises identifying the portion of the structures in the second group for which time since the maintenance action was performed exceeds the correction duration estimate (X_{A}), and wherein the actual correction duration value is defined to be the time since the maintenance action was performed for the portion of the structures in the second group.

6. The method according to claim 5 wherein generation of the FDE comprises determining a sum of the actual correction duration values for the first group and the portion of the second group, and dividing the sum by a total number of structures that are included in the first group and the portion of the second group.

7. The method according to claim 1 wherein a system reset comprises a maintenance action.

8. The method according to claim 1 wherein only actions that resolve the issue, at least temporarily, comprise a maintenance action.

9. A computing system for providing information relating to maintenance actions to address an issue, the computing system comprising processing circuitry configured to:
for a respective issue, identify the maintenance actions that have been performed to correct the issue and that have corrected the issue;
for each respective identified maintenance action, identify a first group of structures wherein the issue has reoccurred and a second group of structures wherein the issue has not reoccurred;
determine an actual correction duration value for each of the identified structures in the first and second groups;
generate a correction duration estimate (X_{A}) for the structures in the first group using the actual correction duration values;
use the correction duration estimate (X_{A}) to identify a portion of the structures in the second group;
use the actual correction duration values calculated for the first group and the portion of the second group to generate a fix duration estimate (FDE) representing an overall time estimation for reoccurrence of the issue; and
cause the FDE to be presented in association with the respective maintenance action to the user.

10. The computing system of claim 9 wherein the processing circuitry is further configured to:
generate an FDE for each identified maintenance action; and
present the FDEs and the associated maintenance actions as a list for each issue being addressed.

11. The computing system of claim 9 wherein the processing circuitry is configured to cause the FDE to be presented by presenting the FDE in association with a confidence score for the respective maintenance action.

12. The computing system according to claim 9 wherein the FDE is generated without consideration of the structures that have undergone the respective maintenance action to address the issue that has not since reoccurred and for which an elapsed time since performance of the respective maintenance action is less than the correction duration estimate (X_{A}).

13. The computing system according to claim 9 wherein the processing circuitry is configured to use the correction duration estimate (X_{A}) to identify the portion of the structures in the second group by identifying the portion of the structures in the second group for which time since the maintenance action was performed exceeds the correction duration estimate (X_{A}), and wherein the actual correction duration value is defined to be the time since the maintenance action was performed for the portion of the structures in the second group.

14. The computing system according to claim 13 wherein the processing circuitry is configured to generate the FDE by determining a sum of the actual correction duration values for the first group and the portion of the second group, and by dividing the sum by a total number of structures that are included in the first group and the portion of the second group.

15. A computer program product for providing information relating to maintenance actions to address an issue, the computer program product comprising at least one non-transitory computer-readable storage medium having computer-executable program code instructions stored therein, the computer-executable program code instructions comprising program code instructions for:
for a respective issue, identifying the maintenance actions that have been performed to correct the issue and that have corrected the issue;
for each respective identified maintenance action, identifying a first group of structures wherein the issue has reoccurred and a second group of structures wherein the issue has not reoccurred;
determining an actual correction duration value for each of the identified structures in the first and second groups;
generating a correction duration estimate (X_{A}) for the structures in the first group using the actual correction duration values;
using the correction duration estimate (X_{A}) to identify a portion of the structures in the second group;
using the actual correction duration values calculated for the first group and the portion of the second group to generate a fix duration estimate (FDE) representing an overall time estimation for reoccurrence of the issue; and
causing the FDE to be presented in association with the respective maintenance action to the user.

16. The computer program product of claim 15 wherein the computer-executable program code instructions further comprise program code instructions for:
generating an FDE for each identified maintenance action; and
presenting the FDEs and the associated maintenance actions as a list for each issue being addressed.

17. The computer program product of claim 15 wherein the program code instructions for causing the FDE to be presented comprise program code instructions for presenting the FDE in association with a confidence score for the respective maintenance action.

18. The computer program product according to claim 15 wherein the FDE is generated without consideration of the structures that have undergone the respective maintenance action to address the issue that has not since reoccurred and for which an elapsed time since performance of the respective maintenance action is less than the correction duration estimate (X_{A}).

19. The computer program product according to claim 15 wherein the program code instructions for using the correction duration estimate (X_{A}) to identify the portion of the structures in the second group comprise program code instructions for identifying the portion of the structures in the second group for which time since the maintenance action was performed exceeds the correction duration estimate (X_{A}), and wherein the actual correction duration value is defined to be the time since the maintenance action was performed for the portion of the structures in the second group.

20. The computer program product according to claim 18 wherein the program code instructions for generating the FDE comprise program code instructions for determining a sum of the actual correction duration values for the first group and the portion of the second group, and program code instructions for dividing the sum by a total number of structures that are included in the first group and the portion of the second group.
